(19) United States
(12) Patent Application Publication
(10) Pub. No.: US 2015/0270730 A1
(43) Pub. Date: Sep. 24, 2015

(54) METHOD AND APPARATUS FOR PROVIDING CHARGING ALERTS

(71) Applicant: MOTOROLA MOBILITY LLC, Chicago, IL (US)

(72) Inventors: Rachit Mittal, Bangalore (IN); Amit Kumar Agrawal, Bangalore (IN)

(73) Assignee: MOTOROLA MOBILITY LLC, Chicago, IL (US)

(21) Appl. No.: 14/219,080

(22) Filed: Mar. 19, 2014

(51) Int. Cl. H02J 7/00; G08B 21/24

(52) U.S. Cl. CPC H02J 7/0047; H02J 7/0027; G08B 21/24

(57) ABSTRACT

A method and apparatus for providing charging alerts includes an electronic device detecting an indication of an event and determining that the event makes a charging opportunity at least partially unavailable for the electronic device. The method further includes the electronic device responsively determining a set of charging solutions and presenting an alert, using the electronic device, which indicates at least a first charging solution in the set of charging solutions.

### FIELD OF THE DISCLOSURE

The present disclosure relates generally to an electronic device providing charging alerts and more particularly to the electronic device providing a charging alert with a charging solution when an event makes a charging opportunity at least partially unavailable for the electronic device.

### BACKGROUND

Mobile electronic devices having self-contained power sources, such as smartphones and tablets, continue to evolve through increasing levels of performance and functionality as manufacturers design feature-rich products that offer consumers greater convenience and productivity. Today, a single smartphone can operate as a phone, two-way radio, media player, web browser, Global Positioning System receiver, camera, personal digital assistant, gaming device, and remote control where separate, dedicated devices would have been required at the turn of the century.

These numerous features mean that mobile electronic devices are now relied on more frequently and that they have become an integral part of people's lives. Frequent use of a mobile electronic device, however, reduces the amount of time a charge of the device lasts to support tasks and events for which the device is needed. Further, as a user carries his or her mobile electronic devices almost continuously, events occurring during the user's day, whether scheduled or unscheduled, can result in missing opportunities to charge the device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an illustration of an electronic device in accordance with some embodiments of the present teachings.

FIG. 2 is a block diagram of an electronic device in accordance with some embodiments of the present teachings.

FIG. 3 is a logical flowchart depicting a method for presenting a charging alert in accordance with some embodiments of the present teachings.

FIG. 4 is a schematic diagram depicting the presentation of a charging alert in accordance with some embodiments of the present teachings.

FIG. 5 is a schematic diagram depicting the presentation of a charging alert in accordance with some embodiments of the present teachings.

FIG. 6 is a schematic diagram depicting the presentation of a charging alert in accordance with some embodiments of the present teachings.

FIG. 7 is a schematic diagram depicting the presentation of a charging alert in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order presented. It will be further appreciated that certain actions and/or steps may be described or depicted in a particular order of occurrence while those skilled in the art will understand that such specificity with respect to sequence is not actually required.

The apparatus and method components have been represented, where appropriate, by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to various embodiments described herein, the present disclosure provides a method and apparatus for providing charging alerts whereby an electronic device indicates a charging solution when an event makes a charging opportunity at least partially unavailable so the electronic device can acquire charge during an alternate charging opportunity. In accordance with the teachings herein is a method performed by an electronic device for providing charging alerts that includes the electronic device detecting an indication of an event and determining that the event makes a charging opportunity at least partially unavailable for the electronic device. The method further includes the electronic device responsively determining a set of charging solutions and presenting an alert, using the electronic device, which indicates at least a first charging solution in the set of charging solutions.

Also in accordance with the teachings herein is an electronic device configured to provide charging alerts. The electronic device includes a user interface and a self-contained power source configured to power the electronic device. The electronic device further includes a processing element coupled to the self-contained power source and the user interface, wherein the processing element is configured to detect an indication of an event and determine that the event makes a charging opportunity at least partially unavailable for the electronic device. The processing element is further configured to responsively determine a set of charging solutions and to present an alert, using the user interface, which indicates at least a first charging solution in the set of charging solutions. In a particular embodiment, the electronic device further includes an acoustic transducer configured to emit an audible sound with the alert.

In one embodiment, the processing element is configured to determine that the event makes a charging opportunity fully unavailable. The processing element is also configured to determine the set of charging solutions to include an amount of charging needed prior to the event to keep the electronic device powered until a next charging opportunity after the event.

In a further embodiment, the processing element is additionally configured to perform at least one of: detect that an alternative charging opportunity is available when the indication of the event is detected, wherein the processing element first presents the alert during the alternative charging opportunity; detect that an alternative charging opportunity is unavailable when the indication of the event is detected, wherein the processing element first presents the alert during a next available charging opportunity occurring before the event; or detect that an alternative charging opportunity is unavailable when the indication of the event is detected, wherein the processing element first presents the alert before a next available charging opportunity occurring before the event.

In another embodiment, the processing element is configured to determine that the event makes a charging opportunity partially unavailable. The processing element is also configured to determine the set of charging solutions to include a first amount of charging needed prior to the event to keep the electronic device powered until a next fully available charging opportunity after the event given a second amount of charging received during the partially unavailable charging opportunity.

For an additional embodiment, the processing element is configured to determine the set of charging solutions to include an amount of charging needed prior to the event to keep the electronic device powered until at least one of: a next confirmed charging opportunity available after the event; a next unconfirmed charging opportunity available after the event; a next regular charging opportunity available after the event; or a next irregular charging opportunity available after the event. For this embodiment, whether a charging opportunity is regular or irregular is based on a charging history for the electronic device.

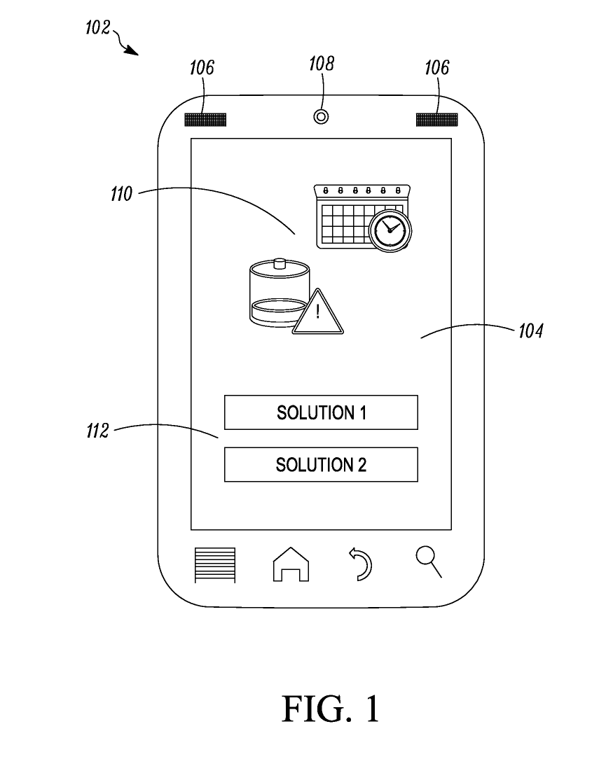

Referring now to the drawings, and in particular FIG. 1, an electronic device (also referred to herein simply as a “device”) implementing embodiments in accordance with the present teachings is shown and indicated generally at 102. Specifically, device 102 represents a smartphone that includes: a touchscreen 104, speakers 106, and a microphone 108. While two stereo speakers 106 and a single monaural microphone 108 are shown for the device 102, other devices consistent with the teachings herein may have different numbers of speakers and/or microphones including devices with no speakers and/or microphones. Being displayed by the touchscreen 104 is an icon 110 for an event that makes a charging opportunity at least partially unavailable and a set of charging solutions 112 for charging the device 102 during an alternate charging opportunity.

An “event,” as used herein, is defined to be an occurrence or activity at an arranged time that can prevent an electronic device from being charged. An event can involve the use of an electronic device or govern the location of the electronic device, either geographically or in relation to a user of the electronic device.

In a first example, a video conference is an event that allows participants to remotely meet at a particular time using, for instance, a video conferencing application within the participants' respective electronic devices. In this instance, the video conferencing application involves the use of an electronic device.

In a second example, going to a concert at a particular time is an event that involves a user viewing a live performance. In this instance, the electronic device is at a location of a concert hall at the particular time. Further, the electronic device might be in a powered-down state while at the concert hall.

In a third example, a user taking a state bar examination is an event that affects the location of an electronic device in relation to the location of the user. In this instance, a rule that precludes the user from bringing electronic devices to the examination means that an electronic device will not be with the user during the examination.

A “charging opportunity,” as used herein, is defined to be a time period during which an electronic device is or can be recharged. In a first example, an electronic device determines that each weekday evening from 8:00 post meridiem (PM) to 10:00 PM is a charging opportunity for the device based on a charging history for the device. For instance, a user regularly plugs the device into a charger on weekdays between 8:00 PM and 10:00 PM.

In a second example, the electronic device determines that each weekday morning from 10:00 ante meridiem (AM) to 11:00 AM is a charging opportunity for the device based on a location history of the device. For instance, the user regularly has his device with him in his office on weekdays between 10:00 AM and 11:00 AM where power receptacles are available for recharging the device. For a particular embodiment, a Global Positioning System (GPS) capability of the device enables the device to determine its location.

While a smartphone is shown at 102, no such restriction is intended or implied as to the type of device to which these teachings may be applied. Other suitable devices include, but are not limited to: personal digital assistants (PDAs); audio- and video-file players (e.g., MP3 players); personal computing devices, such as tablets and laptops; and wearable electronic devices, such as devices worn with a wristband. For purposes of these teachings, a device can be any electronic apparatus that is rechargeable and can provide charging alerts.

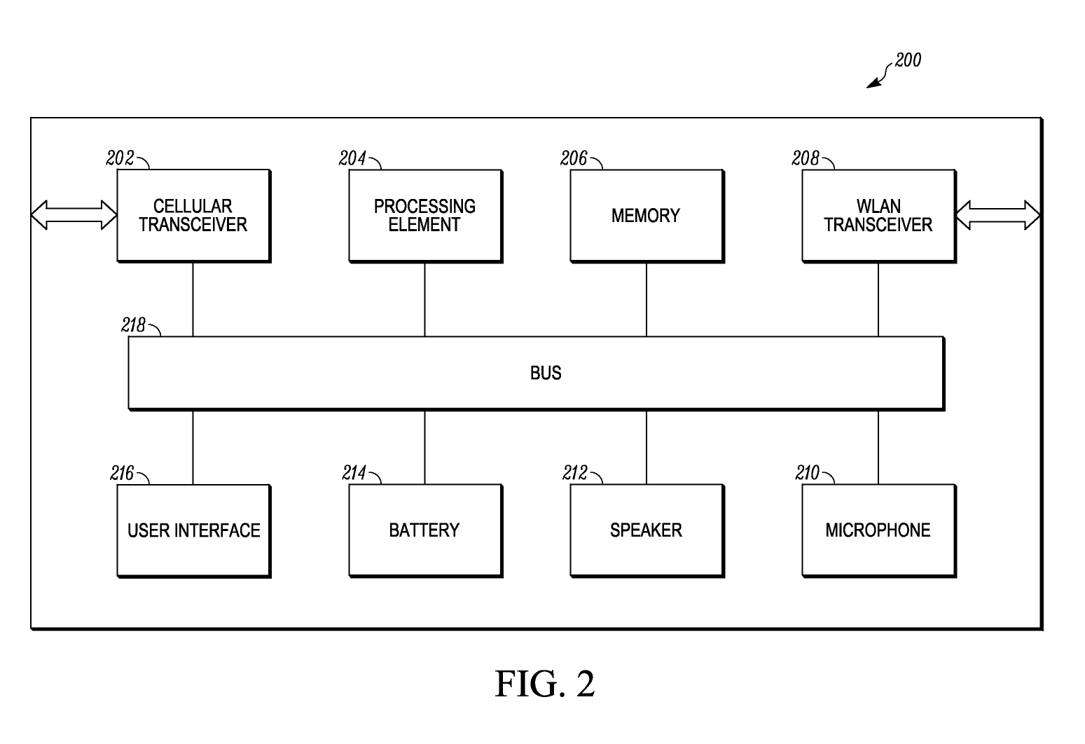

Referring to FIG. 2, a block diagram illustrating some hardware elements of an electronic device in accordance with embodiments of the present teachings is shown and indicated generally at 200. For one embodiment, the block diagram 200 represents some of the elements of the device 102. Specifically, the block diagram 200 shows: a cellular transceiver 202, a processing element 204, memory 206, a wireless local area network (WLAN) transceiver 208, a microphone 210, a speaker 212, a battery 214, and a user interface 216 which are all operationally interconnected by a bus 218.

A limited number of device elements 202, 204, 206, 208, 210, 212, 214, 216 and 218 are shown at 200 for ease of illustration, but other embodiments may include a lesser or greater number of such elements in a device. Moreover, other elements needed for a commercial embodiment of a device that incorporates the elements shown at 200 are omitted from FIG. 2 for clarity in describing the enclosed embodiments.

We now turn to a brief description of the elements within the schematic diagram 200. In general, the processing element 204 and the user interface 216 are configured with functionality in accordance with embodiments of the present disclosure as described in detail below with respect to the remaining figures. “Adapted,” “operative,” “capable” or “configured,” as used herein, means that the indicated elements are implemented using one or more hardware elements such as one or more operatively coupled processing cores, memory elements, and interfaces, which may or may not be programmed with software and/or firmware as the means for the indicated elements to implement their desired functionality. Such functionality is supported by the other hardware shown in FIG. 2, including the device elements 202, 206, 208, 210, 212, 214, and 218.

The processing element 204, for instance, includes arithmetic logic and control circuitry necessary to perform the digital processing, in whole or in part, for the electronic device 102 to determine that an event makes a charging opportunity at least partially unavailable and to responsively determine a set of charging solutions. For one embodiment, the processing element 204 represents a primary microprocessor, also referred to as a central processing unit (CPU), of the electronic device 102. For example, the processing element 204 can represent an application processor of a smartphone. In another embodiment, the processing element 204 is an ancillary processor, separate from the CPU, wherein the ancillary processor is dedicated to providing the processing capability, in whole or in part, needed for the device elements of the block diagram 200 to perform at least some of their intended functionality.

The memory 206 provides temporary storage of electronic data used by the processing element 204 in performing its functionality. For one embodiment, the memory 206 represents random access memory (RAM). For other embodiments, the memory 206 represents volatile or non-volatile memory used by the processing element 204 to cache data.

The user interface 216 is a means by which an electronic device and a user of the electronic device exchange information. It represents one or more hardware elements that facilitate human-device interaction. By using the user interface 216, the device can provide output to the user. Further, for some embodiments, the user can also provide input to the device. In a first example, the device uses the user interface 216 to prompt the user to select a charging solution, and the user uses the user interface 216 to indicate his selection to the device. In a second example, the device uses the user interface 216 to make the user aware of a status of the device, but the device does not await or receive input from the user.

In one embodiment, the user interface 216 represents the touchscreen 104, of the device 102, which visually displays information and receives tactile input. The device 102 prompts the user for input, for instance, by visually displaying the set of options indicated at 112. The user responsively indicates his selection to the device 102 by tapping on or swiping over the option of his choice. In a different embodiment, the user interface 216 represents a display which displays information but does not receive input.

For another embodiment, the speaker 212 and the microphone 210 collectively represent a secondary user interface for a device that is separate from, and in addition to, the primary user interface 216. For example, the device 102 has the speakers 106 and the microphone 108 in addition to the touchscreen 104. The touchscreen 104 represents the primary user interface 216, while the speakers 106 and microphone 108 represent the secondary user interface. The device 102 can produce an alert by generating an audible tone or message using the speakers 106, and a user can respond by speaking into the microphone 108. The device 102 then uses voice recognition software and/or hardware to interpret the user's spoken message. In a particular embodiment for which a device lacks a touchscreen, the speaker 212 and microphone 210 represent a primary (and possibly the only) user interface. In other embodiments, different hardware elements function as the user interface 216 whereby a device and a user can interact. In a particular embodiment, a device uses a display screen to present output to a user, and the device uses a keypad or keyboard to receive input from the user.

The cellular transceiver 202 enables the device 102 to upload and download data to and from one or more cellular networks. This includes, but is not limited to, the device 102 using a cellular network to send and receive video, voice and/or text data to and from other peer devices with similar capabilities for sending and receiving data. Cellular networks can use any wireless technology that, for example, enables broadband and Internet Protocol (IP) communications including, but not limited to, 3^{rd} Generation (3G) wireless technologies such as CDMA2000 and Universal Mobile Telecommunications System (UMTS) networks or 4^{th} Generation (4G) or pre-4G wireless networks such as LTE and WiMAX.

The WLAN transceiver 208 allows the device 102 direct access to the Internet using standards such as Wi-Fi, which is offered at hotspots. The WLAN transceiver 208 allows the device 102 to send and receive radio signals to and from similarly equipped electronic devices using a wireless distribution method, such as a spread-spectrum or orthogonal frequency-division multiplexing (OFDM) method. For embodiments, the WLAN transceiver 208 uses an IEEE 802.11 standard to communicate with other electronic devices in the 2.4, 3.6, 5, and 60 GHz frequency bands. In a particular embodiment, the WLAN transceiver 208 uses Wi-Fi interoperability standards as specified by the Wi-Fi Alliance to communicate with other Wi-Fi certified devices. Other IEEE 802.11-compliant devices with which the device 102 can communicate include, but are not limited to: wireless access points (WAPs), peer devices, and electronic resources. For one embodiment, a device without a cellular transceiver 202 includes a WLAN transceiver 208 used to send and receive wireless communications with peer devices.

The battery 214 represents a self-contained power source that supplies electric power to the device elements 202, 204, 206, 208, 210, 212, 216, 218, as needed, during the course of their normal operation. The power is supplied to meet the individual voltage and load requirements of the device elements 202, 204, 206, 208, 210, 212, 216, 218 that draw electric current. For an embodiment, the battery 214 also powers up and powers down the device 102. The battery 214, or any other power source used, is self-contained in that it powers an electronic device independently of any other power source external to the device. For a particular embodiment, the battery 214 is a rechargeable power source. A rechargeable power source for a device is configured to be temporarily connected to another power source external to the device to restore a charge of the rechargeable power source when it is depleted or less than fully charged.

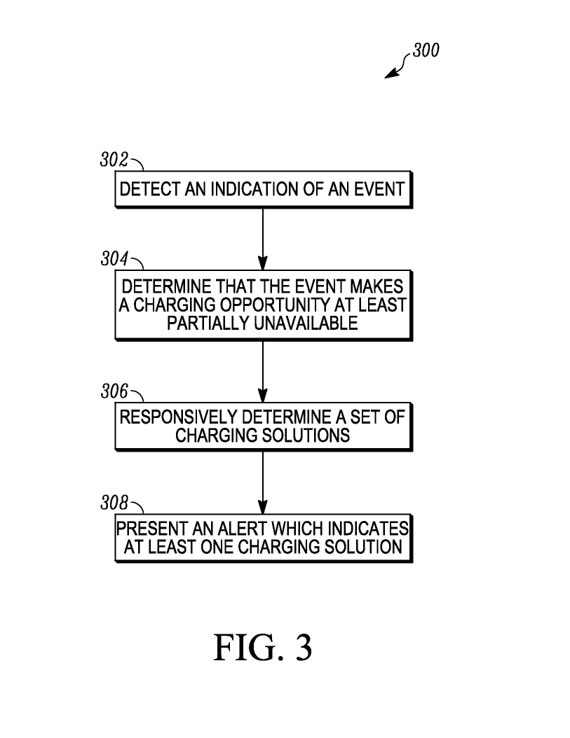

We turn now to a detailed description of the functionality of the device and device elements shown in FIGS. 1 and 2 at 102 and 200, respectively, in accordance with the teachings herein and by reference to the remaining figures. FIG. 3 is a logical flow diagram illustrating a method 300 performed by a device, taken to be device 102 for purposes of this description, for providing charging alerts. Specifically, at 302, the device 102 detects an indication of an event.

The device 102 can detect an indication of an event from a number of sources that include, but are not limited to: calendar invitations, e-mails, text messages, task lists, and social media. Contained within a calendar invitation, for example, is a description of an event and a proposed time that accompanies the event to be calendared. The device 102 determines from the invitation the event to be calendared and also the proposed time the event is to be calendared for. For embodiments for which the device 102 can detect an indication of an event from an e-mail or a text message, the device 102 parses text contained within the e-mail or text message to determine the nature of and proposed time for the event. Using grammatical syntax and comparative algorithms, for instance, the device 102 can identify that an e-mail includes an invitation to a particular event proposed for a specific time. In parsing text, the device 102 can process text in a main body, a header, or any other portion of a written communication.

For one embodiment, individual words and phrases parsed from the e-mail are compared against a database that identifies language associated with specific events. Words such as “movie,” “film,” or “flick” within a threshold proximity to a grammatical (e.g., “seven forty”) or numerical (e.g., “7:40”) indication of a time might be interpreted, in isolation or together with other data, to indicate an invitation to see a motion picture at 7:40 PM. For an outgoing e-mail being sent by the device 102, other data might indicate that prior to drafting the e-mail, a user of the device 102 used a web browser to access a movie listing via the Internet. Further, the device 102 might take into account an increased statistical likelihood that the user intends to see a film based on a day of week the e-mail is sent. An e-mail sent or received on Friday has a higher statistical likelihood to include an invitation to a movie than the same e-mail sent or received on Wednesday, for example. This is especially true if the device 102 has compiled a history of the user attending the movies on Friday and/or the user participating in another activity, such as an evening class, on Wednesday.

For other embodiments, the device 102 parses text received from social networking sites, such as Facebook or Google+, when the sites are accessed by the device 102 via the Internet using the cellular transceiver 202 or WLAN transceiver 208, for example. The text may be from comments previously posted to the social networking sites, or the text may be received in real time using a chat feature supported by the social networking sites. For a particular embodiment, the device 102 sends and receives text directly to and from a peer device using short message service (SMS) without the use of an intermediary social networking application.

In a particular embodiment, the device 102 detects an indication of an event from a task list (e.g., a “to do” list) the user stores on the device 102. The device 102 can detect the indication of the event as the user is typing an entry to the task list or after the entry is submitted to the task list.

After detecting 302 an indication of an event, the device 102 determines 304 that the event makes a charging opportunity at least partially unavailable. Charging opportunities that are at least partially unavailable include charging opportunities that are partially unavailable as well as charging opportunities that are fully unavailable. Determining that an event makes a charging opportunity partially unavailable includes determining that the event overlaps the charging opportunity in time. Similarly, determining that an event makes the charging opportunity fully unavailable includes determining that the event extends throughout the entire charging opportunity. A charging opportunity that was previously available becomes unavailable when it can no longer be used to charge a device due to an event.

In a first example, a user regularly charges his smartphone on weekdays between 6:00 PM and 7:00 PM after arriving home from work. Thursday morning, the user receives an invitation on his smartphone to see a movie that evening between 5:30 PM and 7:30 PM. After the user commits to seeing the movie, for instance, by accepting a calendar invitation or typing an e-mail response, the previously available charging opportunity of Thursday between 6:00 PM and 7:00 PM becomes fully unavailable. The user will be at the movies and not at home where he can charge his smartphone.

In a second example, the user regularly charges his phone at home on Thursday between 7:00 PM and 9:00 PM. With the movie ending at 7:30, it is likely the user will make it home by 8:00 PM. In this instance, the user can still charge his smartphone between 8:00 PM and 9:00 PM. The Thursday evening charging opportunity is only partially unavailable. The user can add some charge to his smartphone but less than an amount he could have had he not committed to see the movie. Continuing the example, if the user agrees to have dinner at a restaurant after the movie, this additional event, together with the movie, will make the Thursday evening charging opportunity fully unavailable.

When the device 102 determines that a detected event makes a charging opportunity at least partially unavailable, it responsively determines 306 a set of charging solutions. As defined herein, a “set” can be a single element or include multiple elements. A charging solution is an action that mitigates or remedies the negative effect of partially or completely missing a charging opportunity. Continuing with an example where an evening at the movies results in a missed charging opportunity, a negative effect is that the smartphone may be unable to provide uninterrupted service throughout the movie and thereafter until the next charging opportunity. Where the smartphone has sufficient charge to operate for the duration of the movie, it may have insufficient charge to remain powered until it can next be charged.

For one embodiment in which an event makes a charging opportunity fully unavailable, the device 102 determines the set of charging solutions to include charging the device 102 prior to the event with a first amount of charge sufficient to keep the device 102 powered until a first charging opportunity after the event. For another embodiment in which an event makes the charging opportunity fully unavailable, the device 102 determines the set of charging solutions to include charging the device 102 prior to the event with a second amount of charge greater than the first amount of charge and sufficient to keep the device 102 powered until a second charging opportunity occurring after the first charging opportunity.

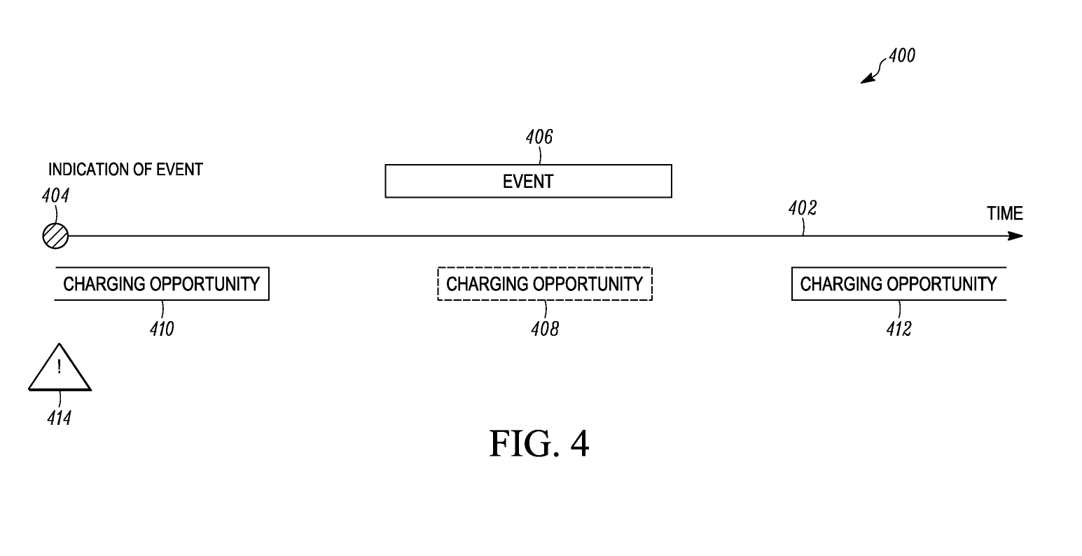

In an embodiment for which an event makes a charging opportunity partially unavailable, the device 102 determining the set of charging solutions includes the device 102 determining a first amount of charging needed during an available charging opportunity prior to the event to power the electronic device to a next available charging opportunity after the event. The device 102 makes this determination given a second amount of charging available to the electronic device during the partially unavailable charging opportunity. More detailed descriptions of charging solutions the device 102 determines in response to charging opportunities becoming at least partially unavailable are provided below with reference to FIGS. 4, 5, 6, and 7.

After determining that an event makes a charging opportunity at least partially unavailable, the device 102 also presents 308 an alert, using the device 102, in which at least one charging solution from the set of charging solutions is indicated. Using the device 102 to present the alert means that one or more hardware elements of the device 102 are utilized to present the alert.

For some embodiments, the device 102 uses the user interface 216 to present the alert, which indicates at least one charging solution. As shown in FIG. 1, for example, the touchscreen 104 represents the user interface 216 upon which the device 102 presents the alert in the form of the icon shown at 110. The alert icon 110 provides notice to a user that an event is making a charging opportunity at least partially unavailable to the device 102. As a result, the device 102 may be left with insufficient charge to operate continuously until a next charging opportunity. A particular type of alert might warn of a danger of interrupted service. The alert icon 110, for example, includes a low-battery indication to make the user aware that uninterrupted service cannot be provided until a next charging opportunity after the event if the user does not take further action. What action the user can take to maintain uninterrupted service is specified by the at least one charging solution indicated at 112.

More specifically, shown at 112 is a pair of charging solutions indicated on the touchscreen 104. For one embodiment, the device 102 presents the pair of charging solutions 112 to the user without an expectation of user input. The user is made aware of the actions he can take to keep the device 102 functioning until a next charging opportunity after the event. It is left to the user to take action without further prompting from the device 102.

For another embodiment, the device 102 presents the pair of charging solutions 112 on the touchscreen 104 with an expectation of user input. The user chooses a charging solution from the set of charging solutions and communicates his choice to the device 102 by tapping on an appropriate button. Upon detecting the user's choice, the device 102 can provide prompts to the user when it is time for the user to take specific actions in accordance with the charging solution chosen. For example, the device 102 might prompt the user to connect the device 102 to a charger at the appropriate time. The device 102 might further provide the user with a time when the device 102 can be disconnected from the charger with an expectation of providing uninterrupted service until a next charging opportunity after the event.

For a further embodiment in which the device 102 expects but does not receive user input, the device 102 provides future prompts to the user in accordance with a default charging solution. For example, if the user does not select a charging solution within a programmed time period, the device 102 assumes a selection. The default solution might be based on criteria such as the greatest convince for the user or the best chance to gain an amount of charge needed given the event.

In a particular embodiment, the device 102 uses its speakers 106 to generate an audible tone, which accompanies the alert presented by the device 102 at 110, as an additional means of indicating to the user, who might not be viewing the touchscreen 104, that an event will make a charging opportunity at least partially unavailable. For a device that lacks a touchscreen, the speakers 106 might be the primary or only means by which the device presents the alert to a user. The speakers 106 might also be used to audibly indicate to the user a set of charging solutions. For an embodiment where the device expects the user to indicate his choice of a charging solution, the user speaks his selection into the microphone 108. Voice-recognition functionality of the device then processes the captured speech to determine the user's selection. For a device equipped with a keypad, the user may use the keypad to enter his selection.

The remaining figures, beginning with FIG. 4, are schematic diagrams 400, 500, 600, 700 that each depict a device, taken to be device 102 for purposes of these descriptions, presenting an alert in accordance with a particular charging solution. FIGS. 4, 5, 6, and 7, respectively, each show a timeline 402, 502, 602, 702 that begins at a time 404, 504, 604, 704 when the device 102 detects an indication of an event 406, 506, 606, 706. More particularly, in FIG. 4, the event 406 makes a charging opportunity 408 fully unavailable. This is indicated in FIG. 4 by the rectangle representing event 406 fully overlapping the rectangle that represents the charging opportunity 408, which appears with a broken line. Without a user taking further action to add additional charge to the device 102 using an alternate charging opportunity 410, the device 102 will deplete its charge before a next charging opportunity 412 is available after the event 406. This is to say that at some point in time, service will be interrupted for the user, either during or after the event 406.

An alert 414 presented by the device 102 provides notice to the user that the charging opportunity 408 is unavailable due to the event 406. For an embodiment, the alert 414 also includes, or is accompanied by, a charging solution that provides the user with information on one or more actions the user can take so that the device 102 can provide uninterrupted service until the charging opportunity 412. For the embodiment shown at 400, the alert 414 indicates charging the device 102 prior to the event 406.

As the device 102 detects at time 404 the indication of the event 406, it detects that the charging opportunity 410 is currently available, that is to say the user can immediately begin charging the device 102 at time 404. The device 102 therefore presents the alert 414 during the currently available charging opportunity 410 to provide notice to the user to begin charging the device 102.

For some embodiments, when the event 406 makes the charging opportunity 408 fully unavailable, determining the set of charging solutions includes determining an amount of charging needed during the available charging opportunity 410 prior to the event 406 to power the device 102 until a next available charging opportunity 412 after the event 406. For a particular embodiment, determining the amount of charge needed includes determining a time period of charging needed. The information is then indicated in the charging solution presented with the alert 414. For example, the device 102 indicates with the alert 414 that the user should connect the device 102 to a charger during the charging opportunity 410 for at a set amount of time that is enough to enjoy uninterrupted service until the charging opportunity 412, for example 24 minutes.

In a further embodiment, if the user disconnects the device 102 from the charger too early during the charging opportunity 410, the device 102 presents another alert (not shown) indicating additional charge is needed to keep the device 102 powered until the charging opportunity 412. If the user disconnects the device 102 from the charger after only 15 minutes instead of the full 24 minutes, for example, the alert presented after the device 102 is disconnected will indicate that 9 more minutes of charging are needed.

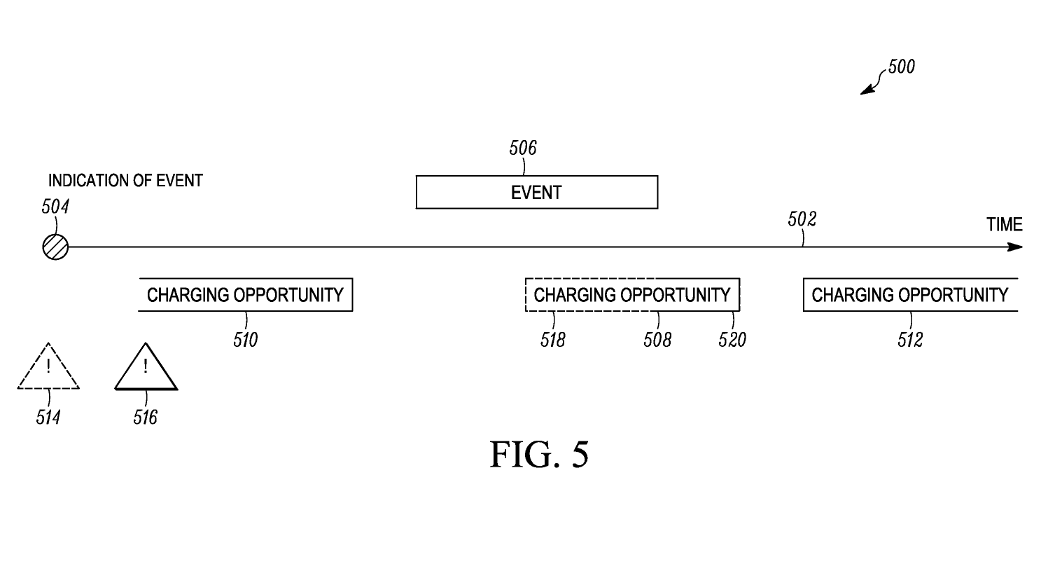

As shown in FIG. 5 at 500, the event 506 makes a charging opportunity 508 partially unavailable. The event 506 overlaps an unavailable portion 518 of the charging opportunity 508, which is shown with a broken line. The device 102 can still be charged during an available portion 520 of the charging opportunity 508, which is shown with a solid line. After the available portion 520 of the charging opportunity 508, a next available charging opportunity 512 after the event 506 is shown open-ended on its right-hand side to indicate the charging opportunity 512 is ongoing. For example, a user plugs in the device 102 into a charger at 8:00 PM and leaves the device 102 plugged in overnight.

For some embodiments, when the event 506 makes the charging opportunity 508 partially unavailable, determining the set of charging solutions includes determining a first amount of charging needed during an available charging opportunity 510 prior to the event 506 to power the device 102 until the next available charging opportunity 512 after the event given a second amount of charging available to the electronic device during the partially unavailable charging opportunity 508. For example, the device 102 determines at time 504 that 40 minutes of charging is needed prior to the event 506 to keep the device 102 functioning until the charging opportunity 512. Further, the device 102 determines that 25 minutes of charging will be gained during the available portion 520 of the charging opportunity 508. The device goes on to determine that 15 minutes of charging is needed during the charging opportunity 510 and provides the user with this information in a charging solution presented with an alert 514 and/or 516.

At the time 504 the device 102 detects the indication of the event 506, the alternative charging opportunity 510 is not yet available (i.e., it is currently unavailable with respect to the time 504). Further, at time 504, no other charging opportunity is available. For example, where the device 102 is in a national park, as determined by a GPS capability of the device 102, the user is unable to connect the device 102 to a charger.

For one embodiment, when the device 102 determines that an alternative charging opportunity is unavailable at the time 504 the device 102 detects the indication of the event 506, the device first presents the alert 516 during a next available charging opportunity 510 prior to the event. Because the user is currently unable to connect the device 102 to a charger, the device 102 waits to alert the user when a charging opportunity is available. For example, if the user calendars an evening at the movies while hiking in a national park, the device 102 waits to alert the user until the user arrives back at his car. Where the user does not have a history of recharging the device 102 in his car, the device 102 waits until the user arrives at home or back at his office before presenting the alert 516.

In another embodiment, when the device 102 determines that an alternative charging opportunity is unavailable at the time 504 the device 102 detects the indication of the event 506, the device first presents the alert 514 before the next available charging opportunity 510 prior to the event 506. The alert 514 is shown with a broken outline, indicating it is an optional alert. At the time 504 the device 102 first determines it will receive less than an expected amount of charge during the charging opportunity 508, the device 102 provides notice with the optional alert 514 that the user should add charge to the device 102 before the event 506. In a particular instance, the optional alert 514 results in the user searching out the charging opportunity 510 before the event 506. For example, the user heads back to the office for 20 minutes to charge the device 102 before meeting a friend at the movies. As the charging opportunity 510 becomes available, the device 102 provides the second alert 516 to remind the user to take advantage of the charging opportunity 510 to add charge to the device 102.

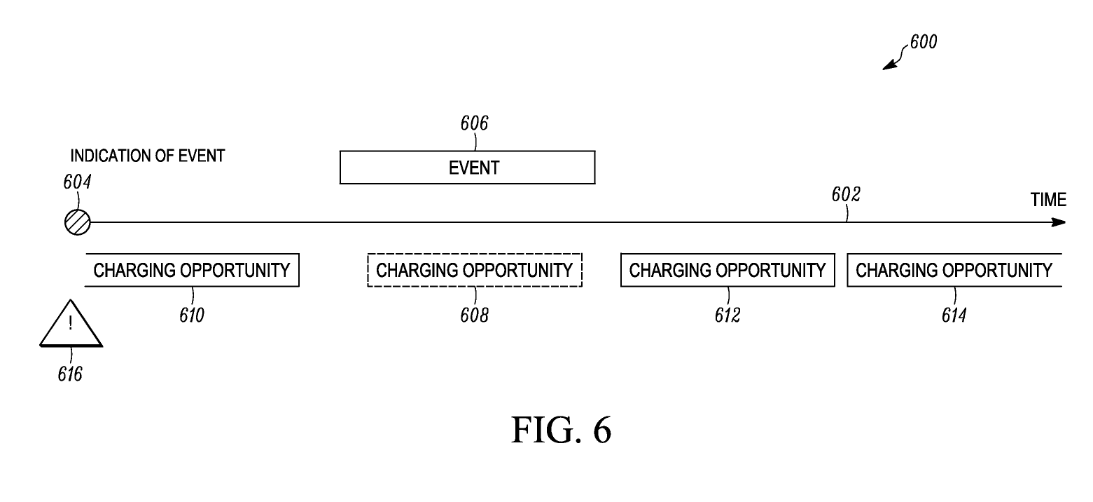

For embodiments represented by the diagram 600 of FIG. 6, two charging opportunities 612, 614 are depicted after the event 606, which makes a charging opportunity 608 fully unavailable. The first and earlier 612 of the two charging opportunities 612, 614 available after the event 606 is closed-ended, indicating the charging opportunity 612 has a definite beginning and end, whereas the second and latter charging opportunity 614 is open-ended only on its right-hand side indicating the charging opportunity 614 has a definite beginning but not a definite end. For example, a user has the opportunity to plug the device 102 into a charger between 5:00 PM and 6:00 PM when he arrives home from work. Additionally, the user regularly leaves the device 102 plugged into the charger overnight beginning at 10:00 PM. At 604, the device 102 detects the event 606 that makes the charging opportunity 608 unavailable and immediately presents an alert 616 during a currently available charging opportunity 610.

In one embodiment, when the device 102 determines that the event 606 makes the charging opportunity 608 fully unavailable, the device 102 determines the set of charging solutions to include a charging solution for charging the device 102 prior to the event 608 with a first amount of charge sufficient to keep the device 102 powered until the first charging opportunity 612 after the event 606. In another embodiment, or for another charging solution, the device 102 determines the charging solution to include charging the device 102 prior to the event 606 with a second amount of charge greater than the first amount of charge. The second amount of charge is sufficient to keep the device 102 powered until the second charging opportunity 614 occurring after the first charging opportunity 612. The first charging opportunity, for example, might be an irregular charging opportunity, whereas the second charging opportunity is a regular charging opportunity. For an embodiment, whether a charging opportunity is regular or irregular is based on a charging history for the device 102.

In the above indicated embodiment, the charging opportunity 614 represents a regular charging opportunity because a charging history compiled for the device indicates that the device 102 is connected to a charger every evening, usually at or about 10:00 PM, and left connected to the charger until the following morning. Where the charging history of the device indicates that the device is repeatedly charged during a same time period for different days, that time period represents a regular charging opportunity for the current and future days.

In a first of two instances, the charging opportunity 612 represents an irregular charging opportunity because the charging opportunity 612 is irregularly used. For example, the user is almost always at home between 5:00 PM and 6:00 PM on weekdays. While the user has the opportunity to connect the device 102 to a charger during this time, the charging history for the device 102 indicates he rarely does. In a second of two instances, the charging opportunity 612 represents an irregular charging opportunity because the charging opportunity 612 is irregularly available. Usually, for example, the user is not at home between 5:00 PM and 6:00 PM. Today, however, the user will be at home during this time, as indicated by a schedule for the user stored on the device 102.

For a plurality of embodiments, the device 102 presents the alert 616 with two charging solutions. The first charging solution indicates a first amount of charging needed (e.g., 20 minutes) during the charging opportunity 610 to keep the device 102 operating until the irregular charging opportunity 612. The second charging solution indicates a second amount of charging needed (e.g., 30 minutes) during the charging opportunity 610 to keep the device 102 operating until the regular charging opportunity 614.

For one embodiment, if the user disconnects the device 102 from a charger during the charging opportunity 610 before the device acquires sufficient charge (e.g., less than 30 minutes of charging) to keep the device 102 operating until the regular charging opportunity 614, the device 102 presents a second alert (not shown) when the irregular charging opportunity becomes currently available. In another embodiment, the device receives 30 minutes of charge during the charging opportunity. However, the device 102 determines during the event 606 that it has insufficient charge to remain powered until the regular charging opportunity 614 because the event is running longer than scheduled. In this instance, the device 102 also provides the second alert when the irregular charging opportunity becomes currently available. Further, the alert includes an amount of charging needed (e.g., 10 minutes) to keep the device 102 powered until the regular charging opportunity 614.

In another embodiment, the first charging opportunity 612 after the event 606 is an unconfirmed charging opportunity and the second charging opportunity 614 after the event 606 is a confirmed charging opportunity. The charging opportunity 614 is confirmed in that the device 102 has information indicating beyond a threshold degree of certainty that the charging opportunity 614 will be available to the device 102. The charging opportunity 612 is unconfirmed because the device 102 lacks information or has insufficient information to indicate beyond a threshold degree of certainty that the charging opportunity 612 will be available to the device 102. The user might indicate in an e-mail, for example, that he will be home by 6:00 PM. Therefore, the device 102 can confirm that the user can avail himself of the charging opportunity 614 beginning at 10:00 PM. The device 102 is unable to deduce from the e-mail, however, if the user will make it home by 5:00 PM to take advantage of the charging opportunity 612. The availability of the charging opportunity 612 might also be in question if the event 606 were open-ended.

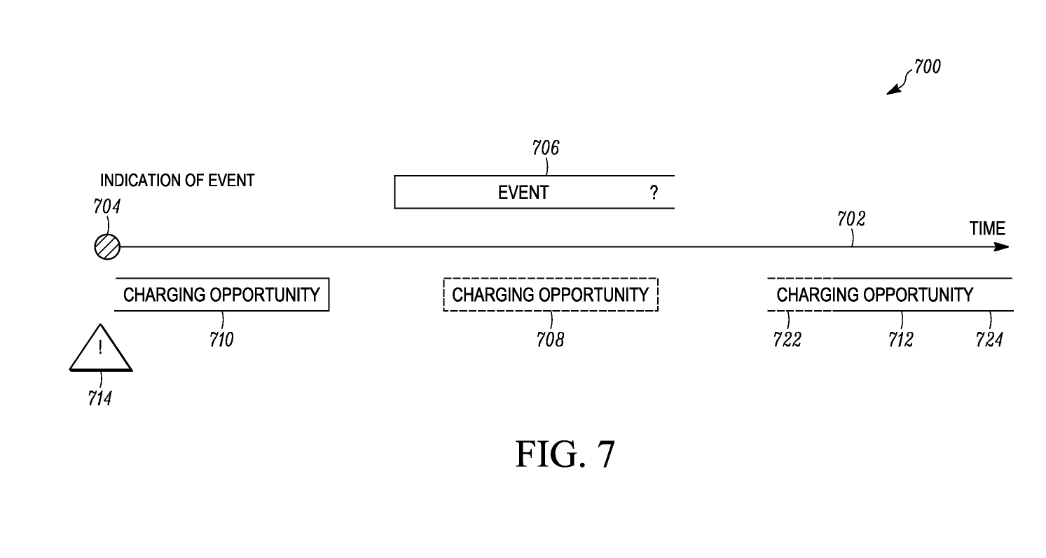

FIG. 7 shows the event 706 as open-ended without a definite end. For example, the user schedules a performance at a theater that begins at 6:00 PM but does not indicate when the performance ends. Additionally, a charging opportunity 712, which has an unavailable portion 722 and an available portion 724, is also shown as open-ended on each side. For an embodiment, the available portion 724 of the charging opportunity 712 begins when the user returns home from the theater. In this embodiment, a charging opportunity 708 is completely unavailable. The device 102, however, is unable to determine exactly when the user will arrive at home until he actually does, or at least until he leaves the theater and begins traveling in the direction of home. If the user decides to go out to dinner after the performance, it will delay the time at which the user arrives home, which for an embodiment is the transition time between the unavailable portion 722 and the available portion 724 of the charging opportunity 712.

For one embodiment, the device provides an alert 714 that indicates an amount of charging for the device 102 prior to the event 706 based on a time of an available charging opportunity 712 after the event. For example, the device 102 bases the amount of charging needed during a charging opportunity 710 on an estimation of when the charging opportunity 712 will transition from an unavailable portion 722 to an available portion. Where the user indicates the performance begins at 6:00 PM, the device 102 might estimate that the user will arrive home at 9:00 PM based on a two-hour performance and an hour of travel time.

In another embodiment, the device 102 provides different charging times with the alert 714 based on different transition times between the unavailable portion 722 and the available portion 724 of the charging opportunity 712. For example, the device 102 indicates at 704 that charging the device for 20 minutes during a charging opportunity 710 will keep the device operating until 9:00 PM and that 30 minutes of charging will keep the device 102 operating until 11:00 PM. The user can then determine an estimated charging time based on when the user expects to arrive home.

For a particular embodiment, the alert 714 further indicates that the charging opportunity 710 is immediately available. If a charging opportunity is available for the event 706 but not immediately available, the alert indicates when the charging opportunity will become available. In the instance that at time 704 no known charging opportunities are available to the device 102 before the event 706, the device provides another alert (not shown) after the alert 714 indicating that a charging opportunity has just become available. If, for example, the user makes an unexpected trip home for lunch, the device 102 alerts the user to charge the device 102 while he is at home to keep his device 102 operating until the next time he arrives at home after the event 706.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by an electronic device for providing charging alerts, the method comprising:
detecting an indication of an event;
determining that the event makes a charging opportunity at least partially unavailable for the electronic device, and responsively determining a set of charging solutions; and
presenting an alert, using the electronic device, which indicates at least a first charging solution in the set of charging solutions.

2. The method of claim 1, wherein the indication of the event is detected from at least one of:
a calendar invite;
a scheduled calendared event;
an e-mail;
a text message;
a task list, or
social media.

3. The method of claim 1, wherein determining that the event makes a charging opportunity partially unavailable comprises determining that the event overlaps the charging opportunity, and determining that the event makes the charging opportunity fully unavailable comprises determining that the event extends throughout the entire charging opportunity.

4. The method of claim 3, wherein when the event makes the charging opportunity fully unavailable, determining the set of charging solutions comprises determining an amount of charging needed during an available charging opportunity prior to the event to power the electronic device until a next available charging opportunity after the event.

5. The method of claim 4, wherein an amount of charging comprises a time period of charging.

6. The method of claim 3, wherein when the event makes the charging opportunity partially unavailable, determining the set of charging solutions comprises determining a first amount of charging needed during an available charging opportunity prior to the event to power the electronic device until a next available charging opportunity after the event given a second amount of charging available to the electronic device during the partially unavailable charging opportunity.

7. The method of claim 1, wherein the presented alert indicates charging the electronic device prior to the event.

8. The method of claim 7 further comprising determining that an alternative charging opportunity is currently available as the electronic device detects the indication of the event, wherein the electronic device presents the alert during the currently available charging opportunity.

9. The method of claim 7 further comprising determining that an alternative charging opportunity is currently unavailable as the electronic device detects the indication of the event, wherein the electronic device presents the alert during a next available charging opportunity prior to the event.

10. The method of claim 7 further comprising determining that an alternative charging opportunity is currently unavailable as the electronic device detects the indication of the event, wherein the electronic device presents the alert before a next available charging opportunity prior to the event.

11. The method of claim 7, wherein the presented alert further indicates at least one of:
an available charging opportunity for charging the electronic device prior to the event; or
an amount of charging for the electronic device prior to the event based on a time of an available charging opportunity after the event.

12. The method of claim 1, wherein the electronic device determines that the event makes the charging opportunity fully unavailable, and wherein the electronic device determines the set of charging solutions to include at least one of:
charging the electronic device prior to the event with a first amount of charge sufficient to keep the electronic device powered until a first charging opportunity after the event; or
charging the electronic device prior to the event with a second amount of charge greater than the first amount of charge and sufficient to keep the electronic device powered until a second charging opportunity occurring after the first charging opportunity.

13. The method of claim 12, wherein the first charging opportunity is an irregular charging opportunity and the second charging opportunity is a regular charging opportunity based on a charging history for the electronic device.

14. The method of claim 12, wherein the first charging opportunity is an unconfirmed charging opportunity and the second charging opportunity is a confirmed charging opportunity.

15. An electronic device configured to provide charging alerts, the electronic device comprising:
a self-contained power source configured to power the electronic device;
a user interface; and
a processing element coupled to the self-contained power source and the user interface, wherein the processing element is configured to:
detect an indication of an event;
determine that the event makes a charging opportunity at least partially unavailable for the electronic device, and responsively determine a set of charging solutions; and
present an alert, using the user interface, which indicates at least a first charging solution in the set of charging solutions.

16. The electronic device of claim 15, wherein the processing element is configured to determine that the event makes a charging opportunity fully unavailable, and to determine the set of charging solutions to include an amount of charging needed prior to the event to keep the electronic device powered until a next charging opportunity after the event.

17. The electronic device of claim 16, wherein the processing element is further configured to perform at least one of:
detect that an alternative charging opportunity is available when the indication of the event is detected, wherein the processing element first presents the alert during the alternative charging opportunity;
detect that an alternative charging opportunity is unavailable when the indication of the event is detected, wherein the processing element first presents the alert during a next available charging opportunity occurring before the event; or
detect that an alternative charging opportunity is unavailable when the indication of the event is detected, wherein the processing element first presents the alert before a next available charging opportunity occurring before the event.

18. The electronic device of claim 15, wherein the processing element is configured to determine that the event makes a charging opportunity partially unavailable, and to determine the set of charging solutions to include a first amount of charging needed prior to the event to keep the electronic device powered until a next fully available charging opportunity after the event given a second amount of charging received during the partially unavailable charging opportunity.

19. The electronic device of claim 15, wherein the processing element is configured to determine the set of charging solutions to include an amount of charging needed prior to the event to keep the electronic device powered until at least one of:
a next confirmed charging opportunity available after the event;
a next unconfirmed charging opportunity available after the event;
a next regular charging opportunity, based on a charging history for the electronic device, available after the event; or
a next irregular charging opportunity, based on a charging history for the electronic device, available after the event.

20. The electronic device of claim 15 further comprising an acoustic transducer configured to emit an audible sound with the alert.
